(19) United States
(12) Patent Application Publication
(10) Pub. No.: US 2012/0281154 A1
(43) Pub. Date: Nov. 8, 2012

(54) LIGHTING DEVICE, DISPLAY DEVICE, AND TELEVISION RECEIVER

(75) Inventor: Ryuhichi Yokoyama, Osaka-shi (JP)

(73) Assignee: SHARP KABUSHIKI KAISHA, Osaka-shi, Osaka (JP)

(21) Appl. No.: 13/521,517

(22) PCT Filed: Jan. 13, 2011
(86) PCT No.: PCT/JP2011/050409

§ 371 Date: Jul. 11, 2012

(30) Foreign Application Priority Data
Jan. 19, 2010 (JP) 2010-008996

(51) Int. Cl. G02F 1/13357; H04N 3/10; F21V 7/10

(52) U.S. Cl. 348/790; 362/235; 349/62; 348/E03.011

(57) ABSTRACT

In a lighting device, unevenness is less likely to be caused in exited light. A backlight unit 12 includes LEDs 17 as light sources, at least two LED boards 18 having the LEDs 17 thereon, a connecting portion 23 electrically connecting the at least two LED boards 18, and a reflection sheet 21 provided on a mounting surface 18a of the LED boards 18 on which the LEDS 17 are mounted and configured to reflect light. The connecting portion 23 is provided on a surface 18c of the LED board 18 adjacent to both of the mounting surface 18a and a surface 18b opposite to the mounting surface 18a.

### TECHNICAL FIELD

The present invention relates to a lighting device, a display device, and a television receiver.

### BACKGROUND ART

Since a liquid crystal panel for a liquid crystal display device such as a liquid crystal television is not self-luminous, it requires a separate backlight unit as alighting device. The backlight unit is provided behind the liquid crystal panel (on a side opposite to a display surface), and includes a chassis opening at the side of the liquid crystal panel, a light source housed in the chassis, a reflection sheet placed along an inner surface of the chassis and reflecting light toward the opening of the chassis, and an optical member (diffusing sheet or the like) provided at the opening of the chassis for efficiently casting light emitted from the light source toward the liquid crystal panel. Of the above components of the backlight unit, an LED may be used as alight source for example, and in this case, an LED board mounting the LED is housed in the chassis.

An example of a backlight unit using an LED as a light source is described in Patent Document 1.
Patent Document 1: Japanese Unexamined Patent Publication No. 2008-28171

### PROBLEM TO BE SOLVED BY THE INVENTION

In the liquid crystal display device having an LED board as described above, a technique of using a plurality of LED boards connected with each other in series may be adopted to enlarge the display. In this case, each LED board is provided with a connector, and the connectors of adjacent LED boards are connected with each other. Here, providing a connector on the same surface as the mounting surface of the LED board mounting an LED may lead to the following problems. That is, the connector forms a step between the mounting surface of the LED board and the connector, and therefore when a reflection sheet reflecting light in the chassis is placed along the mounting surface, the reflection sheet is easily deformed because the reflection sheet rides on the connector, for example. If the reflection sheet deforms, unevenness in reflected light occurs, resulting in that uneven brightness is likely to occur in exited light from the backlight unit.

### DISCLOSURE OF THE PRESENT INVENTION

The present invention was made in view of the foregoing circumstances, and an object of the present invention is to reduce occurrence of unevenness in exited light.

### MEANS FOR SOLVING THE PROBLEM

A lighting device of the present technology includes: a plurality of light sources; at least two light-source boards each having amounting surface on which the plurality of light sources are mounted, an opposite surface that is a surface opposite to the mounting surface, and a side surface that is adjacent to both of the mounting surface and the opposite surface; a connecting portion provided on the side surface of each light source board and configured to electrically connect the at least two light-source boards; and a reflection member provided on the mounting surface of each light-source board and configured to reflect light.

In this manner, the at least two light-source boards are electrically connected with each other by the connecting portion, and light from the light sources is reflected by the reflection member placed on the mounting surfaces of the light-source boards, resulting in that the light is efficiently exited. According to the present technology, the connecting portion is provided on the side surface adjacent to both the mounting surface having the light sources thereon and the opposite surface. Therefore, a step is less likely to be formed on the mounting surface of the light-source board on which the reflection member is placed, as compared with a case that a connecting portion is provided on the mounting surface of the light-source board. In this manner, deformation is less likely to be caused in the reflection member provided on the mounting surfaces of the light-source boards, resulting in that unevenness in light reflected by the reflection member is less likely to occur.

If a connecting portion is provided on the mounting surface of the light-source board, a hole may be formed in the reflection member such that the connecting portion passes therethrough to prevent deformation of the reflection member. However, the connecting portion is exposed through the hole, resulting in that the uniformity of optical reflectance may be harmed. In the present technology, the reflection member is not deformed without forming any hole in the reflection member. Therefore, the uniformity of optical reflectance is maintained and unevenness in exited light is less likely to occur.

If a connecting portion is provided on the opposite surface of light-source board, the connecting portion is hardly seen from the side of the mounting surface in connecting the light-source boars. This may deteriorate the workability and may inhibit slimming down of the backlight unit. According to the present technology, the connecting portion is easily seen from the side of mounting surface in connecting light-source boards. This improves the workability of connection and achieves slimming down of the lighting device.

In the present technology, at least two light-source boards are electrically connected to each other by the connecting portion. Therefore, several types of lighting devices having different sizes are manufactured easily by changing the number of light-source boards connected by the connecting portion. The number of types of light-source boards may be reduced as compared with a case that a light-source board having a specific size is prepared for each type of lighting devices. This achieves reduction of manufacturing cost.

The following structures are preferable in the embodiments of the present invention.

(1) Each of the at least two light-source boards may have an elongated shape. In this configuration, the elongated light-source boards are electrically connected to each other by the connecting portion.

(2) The at least two light-source boards may be aligned along the long-side direction thereof. In this configuration, the at least two light-source boards connected by the connecting portion are aligned along the long-side direction thereof. This is suitable for upsizing the lighting device. As the lighting device is increased in size, the reflection member is also increased in size. This may cause occurrence of deformation. The present technology effectively prevents the deformation of the reflection member.

(3) The connecting portion may be provided at an end of the light-source board in the long-side direction of the light-source board. In this configuration, the connecting portion connecting the at least two light-source boards aligned along the long side direction may be formed in a small size.

(4) The above connecting portion may be provided on a short side surface of each light-source board. In this configuration, the at least two light-source boards are aligned along the long-side direction thereof and their short side surfaces face each other. Providing the connecting portion on the short side surfaces of the light-source boards provides an excellent workability in connecting operation.

(5) The at least two light-source boards may include a plurality of light-source boards having different lengths in the long-side direction. In this configuration, the at least two light-source boards aligned along the long side direction may include those having different lengths in the long-side direction in combination. In this manner, various kinds of lighting devices of different sizes are manufactured effectively.

(6) The at least two light-source boards connected by the connecting portion may configure one light-source board group. A plurality of light-source board groups may be intermittently arranged parallel to each other in the short-side direction of the light-source boards. This configuration is suitable for further upsizing lighting devices.

(7) The plurality of light sources may be arranged along the long-side direction of the above light-source board. In this configuration, the plurality of light sources may be effectively provided on the light-source board, and this is suitable for achieving higher brightness and the like.

(8) The at least two light-source boards may be aligned in one direction along the mounting surface and each of the at least tow light-source boards has a facing surface that faces each other. The connecting portion may be provided on the facing surface of each light-source board. The connecting portion may include a concave connecting portion and a convex connecting portion that are configured to be fitted to each other. The concave connecting portion may be provided on one of the at least two light-source boards. The convex connecting portion may be provided on another one of the at least two light-source boards. In this configuration, the facing surfaces of the adjacent light-source boards are opposed to each other and the convex connecting portion is fitted to the concave connecting portion to achieve connection of the light-source boards. This achieves an excellent workability in the connecting operation.

(9) Each of the light-source boards may have two side surfaces that are provided on opposite sides. The convex connecting portion may be provided on one of the two side surfaces and the concave connecting portion may be provided on another one of the two side surfaces. In this configuration, adjacent light-source boards are formed in the same structure, and this reduces a manufacturing cost.

(10) The convex connecting portion and a periphery of the concave connecting portion may be provided to overlap each other in a thickness direction of the light-source board. In this configuration, adjacent light-source boards are positioned with respect to the thickness direction of the light-source board. In this manner, each light source mounted on the adjacent light-source boards is prevented from being displaced in the thickness direction of the light-source boards.

(11) The lighting device may further include an optical member provided on a light exit side to face the light sources with a gap therebetween. The convex connecting portion and the periphery of the concave connecting portion may be provided to overlapped with each other in a direction from the light sources toward the optical member. In this configuration, adjacent light-source boards are positioned with respect to the direction from the light sources toward the optical member. In this manner, the gap between the light sources and the optical member is kept constant, and unevenness is less likely to be caused in exited light.

(12) A pair of light-source boards of the at least two light-source boards that are located at both ends in an alignment direction in which the at least two light-source boards are aligned may include an external connecting portion provided on a surface of each of the pair of light-source boards that is opposite to the side surface having the connecting portion thereon, and the external connecting portion may be electrically connected to an external connection component. In this configuration, each of the pair of light-source boards located at both ends of the at least two light-source boards in the alignment direction is electrically connected to the external connection component via the external connecting portion provided on the surface opposite to the surface having the connecting portion connecting the adjacent light-source boards. Since the external connecting portion is provided on the surface opposite to the surface having the connecting portion, the external connecting portion is less likely to cause a step on the mounting surface on which the reflection member is provided. In this manner, deformation is less likely to caused in the reflection member provided on the mounting surface, resulting in that unevenness of light reflected by the reflection member is less likely to occur.

(13) The external connecting portion provided on each of the pair of light-source boards may have a concave shape to which the external connection component having a convex shape is fitted. In this configuration, the external connecting portions provided on the pair of light-source boards both has a concave shape, and therefore the external connection components may be one kind of part having a same convex shape. In this manner, the manufacturing cost of external connection components may be reduced.

(14) One of the pair of light-source boards may include the convex connecting portion, and the external connecting portion having a concave shape same as the concave connecting portion configured to fit to the connection component having a convex shape. The other one of the pair of light-source boards may include the concave connecting portion, and the external connecting portion having a convex shape same as the convex connecting portion configured to fit to the connecting component having a concave shape. In this configuration, the concave external connecting portion has the same shape as the concave connecting portion, and the convex external connecting portion has the same shape as the convex connecting portion. Therefore, the light-source boards may be formed as the same component. In this manner, the manufacturing cost of the light-source boards may be reduced.

(15) The convex connecting portion may be protruded from the light-source board in the alignment direction of the at least two light-source boards. The concave connecting portion may be open in the alignment direction of the at least two light-source boards and has a periphery that surrounds the convex connecting portion. In this configuration, the convex connecting portion is surrounded by the periphery of concave connecting portion if the convex connecting portion is fitted to the concave connecting portion. Therefore, they are positioned with respect to the alignment direction of the at least two light-source boards (that is a fitting direction) and also the direction perpendicular to the alignment direction.

(16) The convex connecting portion may be protruded from the light-source board in the alignment direction of the at least two light-source boards, and the concave connecting portion may be open in the alignment direction of the at least two light-source boards and also open in a direction perpendicular to the alignment direction. In this configuration, in fitting the convex connecting portion into the concave connecting portion, one of the two fitting methods may be selected. The two fitting methods include one in which the convex connecting portion is fitted to the concave connecting portion along the alignment direction of the at least two light-source boards and another in which they are fitted to each other in a direction perpendicular to the alignment direction. This improves the workability with respect to connecting operation.

(17) The connecting portion may be provided to be flush with the mounting surface of the light-source board, or provided to be recessed from the mounting surface toward the opposite surface. Such a configuration reliably avoids forming a step protruding from mounting surface of the light-source board. Therefore, it reliably avoids that the reflection member provided on the mounting surface of the light-source board rides on the connecting portion and deforms.

(18) The connecting portion may be provided to be flush with the opposite surface of the light-source board, or provided to be recessed from the opposite surface toward the mounting surface. Such a configuration reliably avoids forming a step protruding from the opposite surface of the light-source board opposite to the mounting surface. This configuration is suitable for installing the light-source board in the lighting device.

(19) The connecting portion may be formed integrally with the light-source board. In this configuration, the manufacturing cost for the light-source boards is reduced.

(20) The light source may include an LED. In this configuration, higher brightness and lower power consumption are achieved.

(21) The lighting device further includes a diffusing lens provided on a light exit side of the light source and configured to diffuse light from the light source. In this configuration, the light emitted from the light source may be exited with being diffused by the diffusing lens. Accordingly, unevenness is less likely to be caused in exited light, and thus the number of light sources to be mounted may be reduced, which allows the reduction of cost.

Secondly, in order to solve the above problem, a display device of an embodiment of the present technology includes the above described lighting device, and a display panel displaying using light from the lighting device.

According to this display device, in the lighting device supplying light to the display panel, the reflection member is less likely to deform and thus uneven brightness of exited light is less likely to occur, resulting in achieving display with excellent quality.

The display panel may be a liquid crystal panel, for example. As a liquid crystal display, such a display device may preferably apply to various applications, such as a display for TVs or personal computers, in particular, for large screen.

### ADVANTAGEOUS EFFECT OF THE INVENTION

According to the present invention, unevenness is less likely to occur in exited light.

### BRIEF DESCRIPTION OF THE DRAWINGS

FIG. 1 is an exploded perspective view of an outline configuration of a television receiver according to a first embodiment of the present invention;

FIG. 2 is an exploded perspective view of an outline configuration of a liquid crystal display device of the television receiver;

FIG. 3 is a plan view depicting the layout of LED boards and hold members in a chassis included in the liquid crystal display device;

FIG. 4 is a sectional view along the line iv-iv of FIG. 3 in the liquid crystal display device;

FIG. 5 is a sectional view along the line v-v of FIG. 3 in the liquid crystal display device;

FIG. 6 is a schematic side view depicting a state before the LED boards and external connectors are connected to each other;

FIG. 7 is an enlarged sectional view depicting a state before two LED boards are connected to each other;

FIG. 8 is an enlarged plan view depicting a state before two LED boards are connected to each other;

FIG. 9 is an enlarged sectional view depicting a state where two LED boards are connected to each other;

FIG. 10 is an enlarged plan view depicting a state where two LED boards are connected to each other;

FIG. 11 is a schematic side view depicting a state where the LED boards and external connectors are connected to each other, but before a reflection sheet is provided;

FIG. 12 is a schematic side view depicting a state where the reflection sheet is provided;

FIG. 13 is an enlarged sectional view depicting a state before two LED boards of a second embodiment of the present invention are connected to each other;

FIG. 14 is an enlarged sectional view depicting a state where two LED boards are connected to each other; and

FIG. 15 is a schematic side view depicting a state before LED boards and external connectors of a third embodiment of the present invention are connected to each other.

### BEST MODE FOR CARRYING OUT THE INVENTION

### First Embodiment

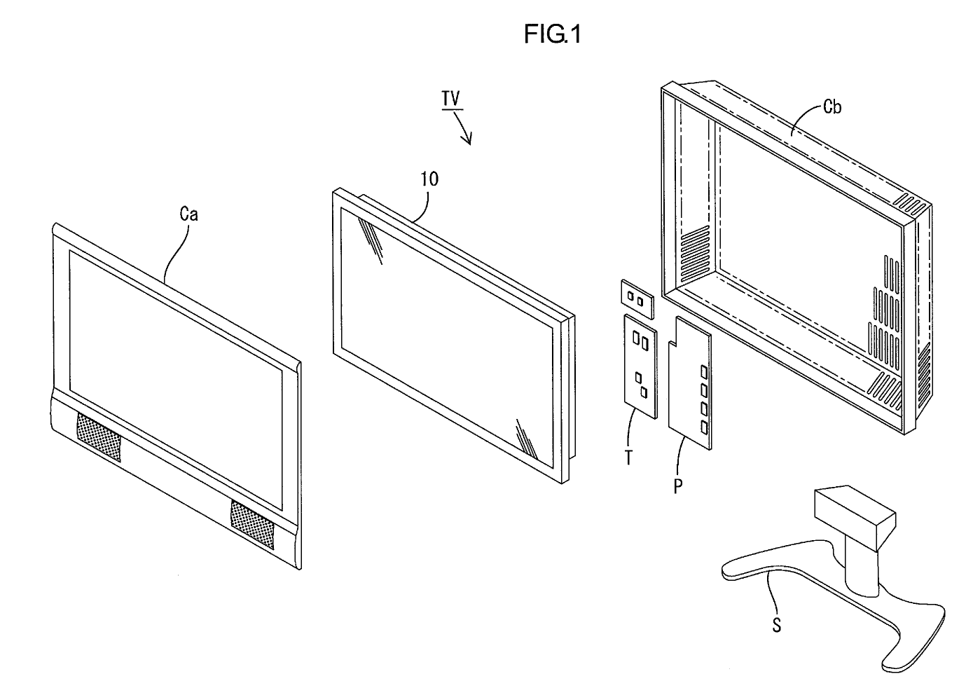

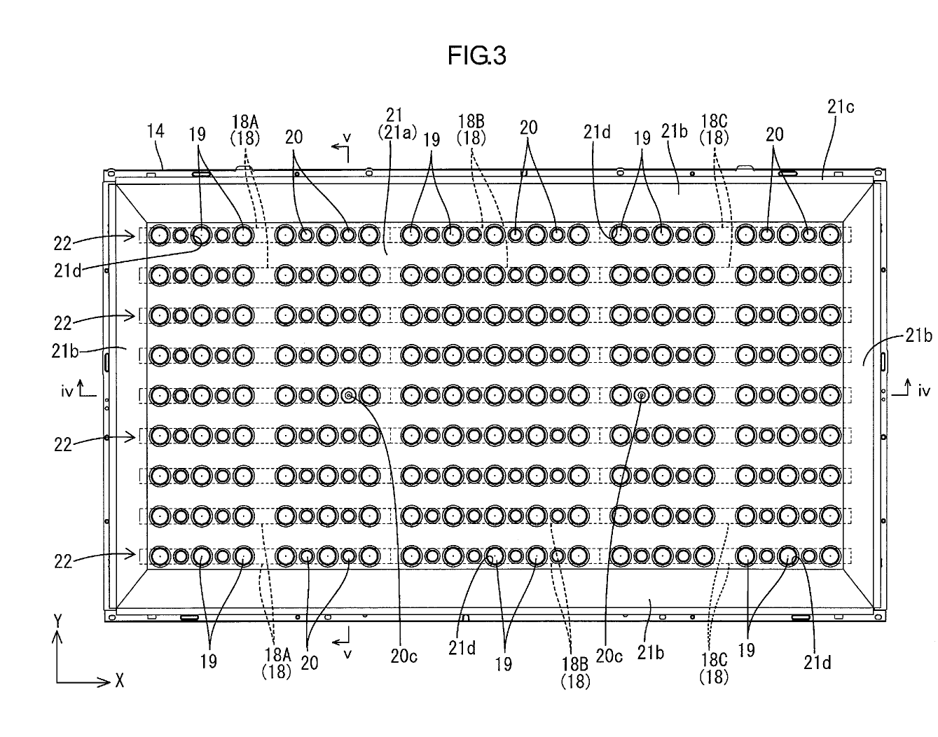

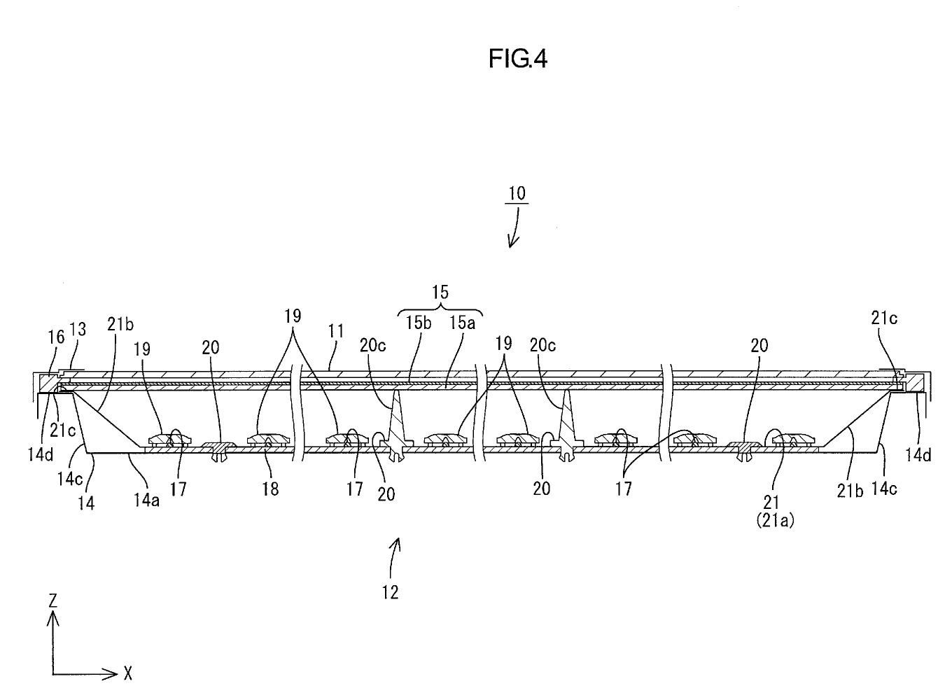

A first embodiment of the present invention will be described with reference to FIGS. 1 to 12. In this embodiment, a liquid crystal display device 10 is exemplified. In a part of the drawings, an X-axis, a Y-axis, and a Z-axis indicate axial directions in the drawings. In addition, the upper side of FIGS. 3 and 4 is defined as the front side, and the lower side is defined as the back side.

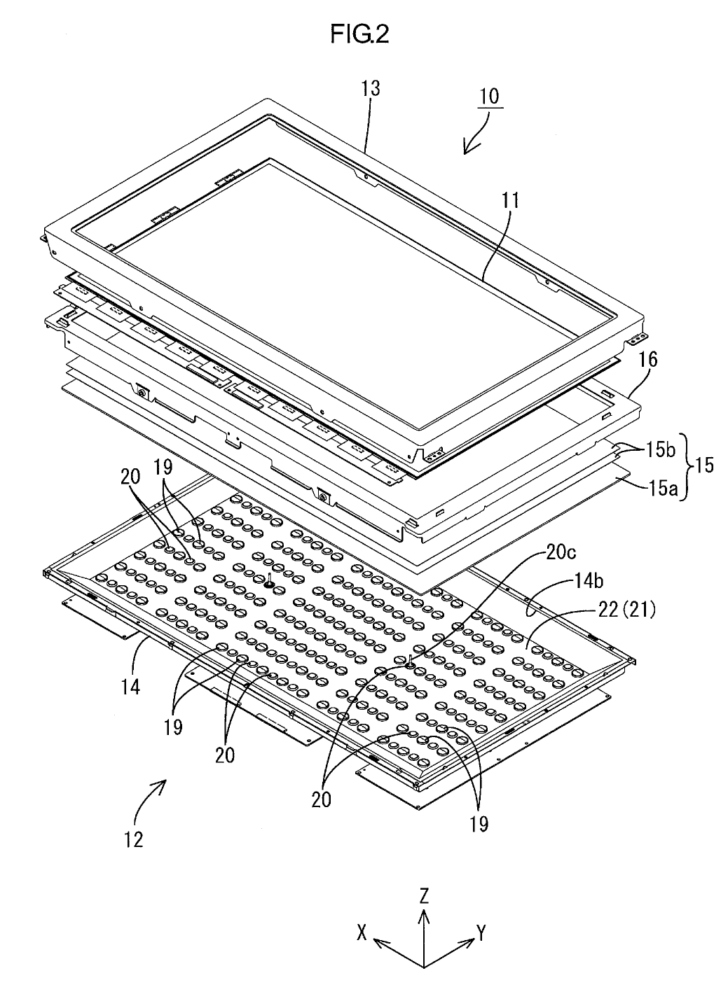

A television receiver TV according to this embodiment includes, as shown in FIG. 1, the liquid crystal display device 10, front and back cabinets Ca and Cb that hold and house the liquid crystal display device 10 therebetween, a power source P, a tuner T, and a stand S. The liquid crystal display device (display device) 10 generally has a horizontally oriented (elongated) rectangular shape, and is housed in a vertical position. The liquid crystal display device 10 includes, as shown in FIG. 2, a liquid crystal panel 11 as a display panel, and a backlight unit (lighting device) 12 as an external light source, which are integrally held by a frame-shaped bezel 13 or the like.

Next, the liquid crystal panel 11 and the backlight unit 12 included in the liquid crystal display device 10 will be described. The liquid crystal panel (display panel) 11 has a rectangular shape on a plan view and is constructed such that a pair of glass substrates is bonded to each other with a predetermined gap therebetween, and a liquid crystal is sealed between the glass substrates. On one of the glass substrates, switching components (for example, TFTs) connected to source lines and gate lines perpendicular to each other, pixel electrodes connected to the switching components, and further an alignment film or the like are provided. On the other glass substrates, a color filter in which color sections of such as R (red), G (green) and B (blue) are provided in a predetermined arrangement, a counter electrode, and further an alignment film or the like are provided. On outsides of the substrates, polarizing plates are provided.

Now, the backlight unit 12 will be described in detail. As shown in FIG. 2, the backlight unit 12 includes a substantially box-shaped chassis 14 with an opening 14b at the light emitting side (liquid crystal panel 11 side), a group of optical members 15 which covers the opening 14b of the chassis 14 (diffuser plate 15a (optical diffuser member), and a plurality of optical sheets 15b provided between the diffuser plate 15a and the liquid crystal panel 11), and a frame 16 which is arranged along the edge of the chassis 14 and holds the edge of the group of optical members 15 between the frame 16 and the chassis 14. Further, the chassis 14 includes an LED 17 (Light Emitting Diode) which is a light source, an LED board 18 mounting an LED 17, and a diffusing lens 19 placed in a position corresponding to the LED 17 on the LED board 18. The chassis 14 further includes: a hold member 20 configured to hold the LED board 18 between the chassis 14 and the hold member 20; and a reflection sheet 21 reflecting light in the chassis 14 toward the optical members 15. In the backlight unit 12, the side closer to the optical members 15 than the LED 17 is the light emitting side. Each component of the backlight unit 12 will be described in detail in the following.

The chassis 14 is made of metal. As shown in FIGS. 3 to 5, the chassis 14 has a base plate 14a having a rectangular shape as in the liquid crystal panel 11, side plates 14c each rising from the outer edge of each side of the base plate 14a toward the front side (light emitting side), and supporting plates 14d each outwardly protruding from the edge of each side plate 14c, and has a shallow, substantially box-shape (substantially shallow plate shape), opening toward the front side as a whole. The long side direction of the chassis 14 aligned with the X-axis direction (horizontal direction), and the short side direction of chassis 14 aligned with the Y-axis direction (vertical direction). Each supporting plate 14d of the chassis 14 is configured to mount the frame 16 and the optical members 15 (described in the following) from the front side. Each supporting plate 14d is attached to the frame 16 with a screw. The base plate 14a of the chassis 14 has mounting holes 14e to mount the hold members 20. In the base plate 14a, a plurality of mounting holes 14e is dispersed in places corresponding to the mounting places of the hold members 20.

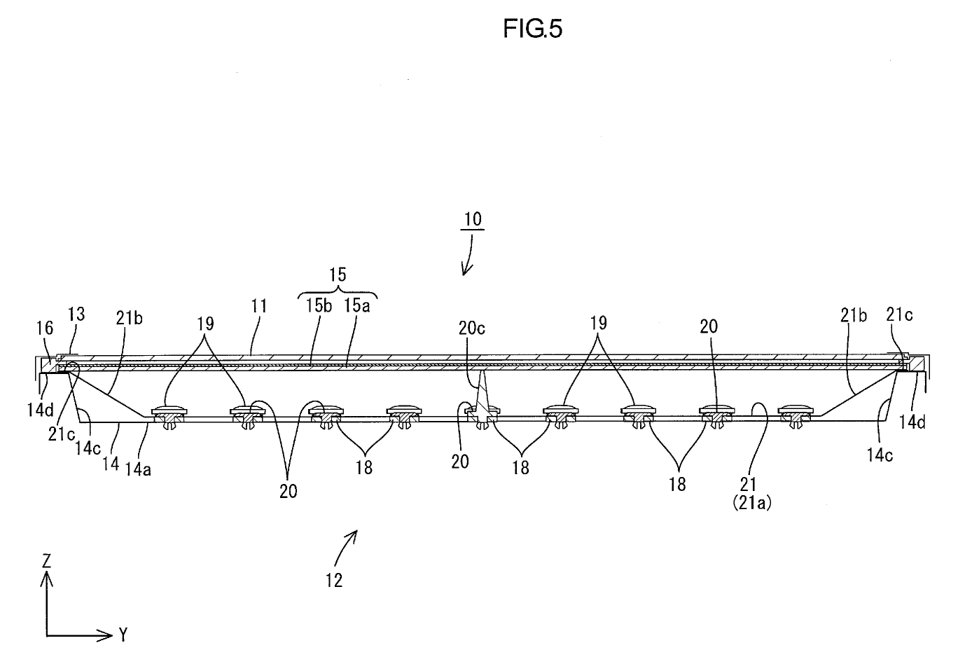

As shown in FIG. 2, the optical members 15 have a rectangular shape on the plan view as in the liquid crystal panel 11 and the chassis 14. As shown in FIGS. 4 and 5, the edges of the optical members 15 are mounted on the supporting plate 14d to cover the opening 14b of the chassis 14, and the optical members 15 are placed between the liquid crystal panel 11 and the LED 17. The optical members 15 include a diffuser panel 15a placed on the back side (LED 17 side, the opposite side of light emitting side), and an optical sheet 15b placed on the front side (liquid crystal panel 11 side, light emitting side). The diffuser plate 15a is configured such that a number of diffusing particles are dispersed within a substrate of substantially transparent resin having a predetermined thickness, and has a function of diffusing transmitted light. The optical sheet 15b has a sheet-like shape thinner than the diffuser plate 15a, and has two layered sheets (FIG. 2). Specific types of the optical sheet 15b are, for example, a diffuser sheet, a lens sheet and a reflection type polarizing sheet, and may be suitably selected.

The frame 16 has a frame-like shape along the periphery of the liquid crystal panel 11 and the optical members 15 as shown in FIG. 2. The optical members 15 are held between the frame 16 and the supporting plates 14d (FIGS. 4 and 5). The frame 16 is configured to receive the edge of the liquid crystal panel 11 from the back side, and to hold the edge of the liquid crystal panel 11 between the frame 16 and the bezel 13 placed on the front side (FIGS. 4 and 5).

As shown in FIG. 4, the LED 17 is configured such that an LED chip is encapsulated by resin on a board adhered to the LED board 18. The LED chip mounted on the board has a single type of dominant emission wavelength, specifically, single color emitting blue. On the other hand, a phosphor is dispersed within the resin which seals the LED chip, and is excited by blue light emitted from an LED chip and emitting a predetermined color, and the resin emits substantially white color as a whole. The phosphor may be suitably selected from any one of a yellow phosphor emitting yellow light, a green phosphor emitting green light and a red phosphor emitting red light, or combination thereof. This LED 17 is a so-called top type where a surface of opposite to a mounting surface with respect to the LED board 18 is a light-emitting surface.

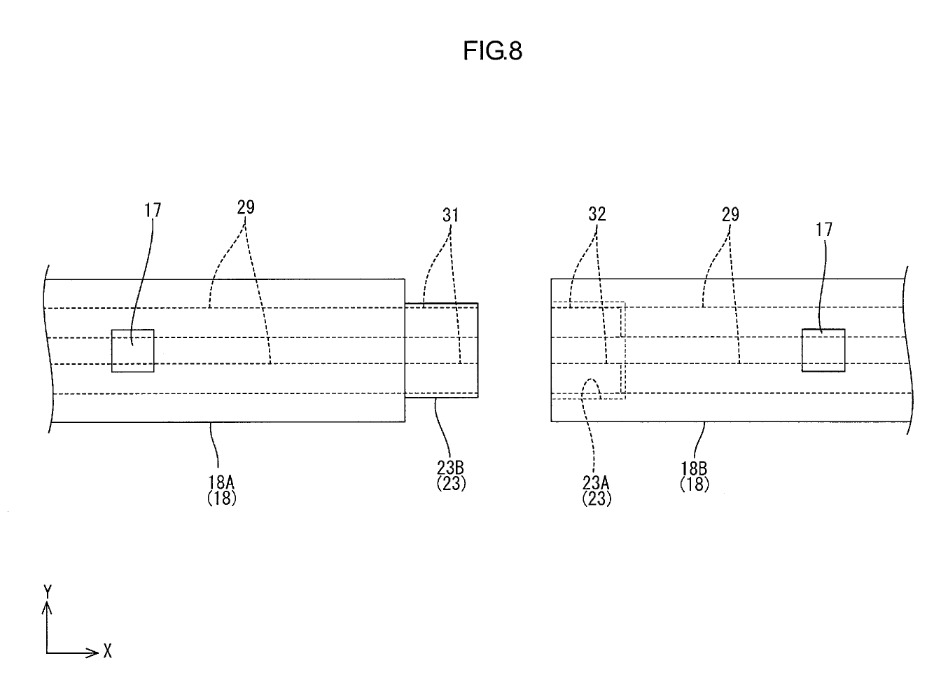

The LED board 18 is made of synthetic resin (epoxy resin) or ceramic, and as shown in FIGS. 3 and 4, has a rectangular shape on the plan view. The LED boards 18 are housed in the chassis 14 along the base plate 14a such that its long side direction aligned with the X-axis direction and its short side direction aligned with the Y-axis direction. Of the main plate surfaces of this LED board 18, the LED 17 of the above configuration is mounted on a surface 18a (surface facing optical member 15) facing the front side. That is, the surface 18a of the front side of the LED board 18 is a mounting surface 18a mounting the LED 17. A surface 18b of the back side of the LED board 18, namely the surface 18b opposite to the above mounting surface 18, is supported from the back side by the base plate 14a of the chassis 14. A plurality of LEDs 17 is arranged linearly and parallel to each other along the long side direction of the LED board 18 (X-axis direction), and is in series connection by a wiring pattern 29, which is made of copper foils and metal membranes and formed on the LED board 18 (see FIG. 8). The array pitch of the LEDs 17 of the LED board 18 is substantially equal, namely the LEDs 17 are arranged equally spaced apart from each other.

As shown in FIG. 3, a plurality of LED boards 18 of the above configuration is arrayed such that the plurality of LED boards 18 is arranged parallel to each other in both the X-axis direction and the Y-axis direction with their long side direction and the short side direction aligned. That is, the LED boards 18 and the LEDs 17 mounted thereon are arranged such that the X-axis direction (the long side direction of chassis 14 and LED board 18) is the line-wise direction and the Y-axis direction (the short side direction of the chassis 14 and the LED board 18) is the row-wise direction within the chassis 14 (arranged in a matrix, plane configuration). Specifically, twenty seven LED boards 18 in total are arrayed parallel to each other within the chassis 14 such that three LED boards 18 are arranged in the X-axis direction and nine LED boards 18 are arranged in the Y-axis direction. In this embodiment, two types of LED boards 18 having different long side dimensions (length in the long side direction) and different numbers of LEDs 17 mounted on the LED boards 18 are used. Specifically, as the LED boards 18, a relatively long side dimension type having six LEDs 17 (six-LED mounting type), and a relatively short side dimension type having five LEDs 17 (five-LED mounting type) are used. One six-LED mounting type is placed at both ends of the X-axis direction in the chassis 14, and one five-LED mounting type is placed at the center in the X-axis direction.

Three LED boards 18 lined in the X-axis direction, namely in the long side direction of the LED boards 18 are electrically connected with each other, and electrically connected with an external drive control circuit (not shown). In this manner, the LEDs 17 mounted parallel to each other on each of the LED boards 18 forming a single row in the X-axis direction are connected in series, and the light-on and off operations of the plurality of LEDs 17 are collectively controlled by the single drive control circuit, resulting in the reduction of the cost. These three LED boards 18 aligned parallel to each other along the X-axis direction and forming a single row may be said to configure an LED boards group 22. Nine LED boards groups 22 are intermittently placed in the Y-axis direction, namely in the short side direction of LED boards 18, parallel to each other. The space (array pitch) between adjacent LED board groups 22 (LED boards 18) in the Y-axis direction is substantially equal. Even though the LED boards 18 are of different types having different long side dimensions and different numbers of LEDs 17 to be mounted, the short side dimension and the array pitch of the LEDs 17 in the X-axis direction are substantially equal.

In this manner, the following advantages may be obtained from the technique that a plurality of LED boards 18 is aligned along the X-axis direction and electrically connected with each other, and different types having different long side dimensions and different numbers of LEDs 17 to be mounted are prepared as the LED boards 18, and the different types of the LED boards 18 are suitably combined and used. That is, when various types of the liquid crystal display devices 10 having different sizes (backlight unit 12 having different sizes) are manufactured, it can be dealt with by deciding to use various LED boards 18 or not, and suitably changing the types of the LED boards 18 and the number of the LED boards 18 of each type, depending on the display sizes. When compared with a case that a specific LED board having the same long side dimension as the chassis 14 is prepared for every display size, the number of necessary types of the LED boards 18 may be significantly reduced, resulting in the reduction of manufacturing costs. Specifically, by adding another type of the LED board 18 having eight LEDs 17 to the above two types of the LED boards 18 (a five-LED mounting type and a six-LED mounting type), and using these three types of the LED boards 18 by suitably combining them, manufacturing cost for the liquid crystal display devices 10 having the display size of, for example, 26 inches, 32 inches, 37 inches, 40 inches, 42 inches, 46 inches, 52 inches, and 65 inches may be easily reduced.

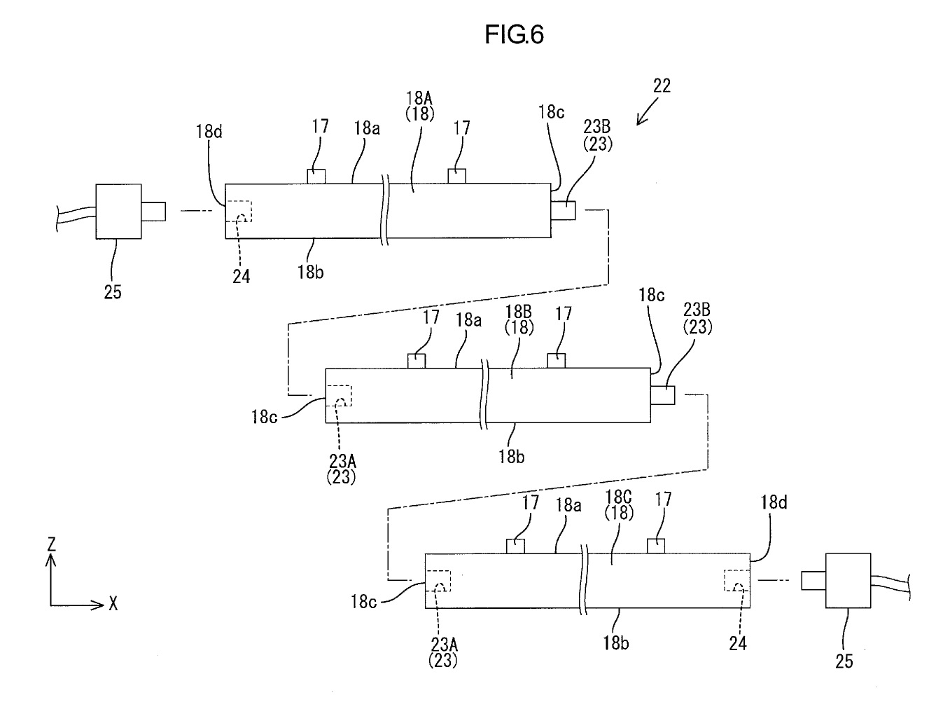

The diffusing lens 19 is made of synthetic resin that is substantially transparent (have a high light transmission) and that has a refractive index higher than air (for example, polycarbonate and acrylic). As shown in FIGS. 3 to 5, the diffusing lens 19 has a predetermined thickness, has a substantially cylindrical shape on the plan view, and is provided such that it covers the corresponding LED 17 from the front side with respect to LED board 18, namely overlaps with the corresponding LED 17 on the plan view. This diffusing lens 19 may emit and diffuse light with high directivity emitted from the LED 17. That is, since the directivity of light emitted from the LED 17 is reduced through the diffusing lens 19, a region between adjacent LEDs 17 is less likely to be recognized as a dark region even though the space between the LEDs 17 are made wider. In this manner, the number of the LEDs 17 to be mounted may be reduced. The same number of diffusing lenses 19 as that of the mounted LEDs 17 on the LED board 18 are mounted, and each diffusing lens 19 is placed in a concentric position with the corresponding LED 17 on the plan view. In FIGS. 6 to 12, the depiction of the diffusing lens 19 is omitted.

The hold member 20 is made of synthetic resin such as polycarbonate, and has a white surface with excellent light reflectivity. As shown in FIGS. 3 to 5, the hold member 20 has: a body 20a along the plate surface of the LED board 18; and a fixed part 20b fixed to the chassis 14 and protruding toward the back side of the body 20a, namely toward the chassis 14. The body 20a has a plate shape having a substantially circular shape on the plan view, and is configured to hold the LED board 18 and the reflection sheet 21 (further explained below) between the body 20a and the base plate 14a of the chassis 14. The fixed part 20b is configured to penetrate the insertion hole 18b and the mounting hole 14e each formed in accordance with the mounting location of the hold member 20 in the LED board 18 and the base plate 14a of the chassis 14, and to engage the base plate 14a. As shown in FIG. 3, a plurality of hold members 20 is arrayed parallel to each other in a matrix on the LED boards 18, and specifically, they are placed in a position between adjacent diffusing lenses 19 (LEDs 17) in the X-axis direction.

Of the hold members 20, a pair of hold members 20 placed at the center of the display has a support portion 20c protruding from the body 20a toward the front side, as shown in FIGS. 2 to 4, and this support portion 20c allows the diffuser plate 15a to be supported from the back side. Accordingly, the positional relationship between the LED 17 and the optical member 15 in the Z-axis direction (the direction perpendicular to the mounting member 18a of LED board 18) is kept fixed and also the inadvertent deformation of the optical member 15 is restricted.

The reflection sheet 21 is made of synthetic resin, and has a white surface with excellent light reflectivity. As shown in FIGS. 3 and 5, since the reflection sheet 21 has a size such that it may be laid on the entire inner surface of the chassis 14, it may cover entire LED boards 18 arrayed in a matrix within the chassis 14 from the front side. This reflection sheet 21 is configured to reflect light within the chassis 14 toward the optical member 15. The reflection sheet 21 has: a base 21a extending along the base plate 14a of the chassis 14 and covering the most part of the base plate 14a; four rising parts 21b rising from each outer end of the base 21a toward the front side, and inclined with respect to the base 21a; and an extension part 21c extending outwardly from the outer end of each rising part 21b and mounted on the supporting plate 14d of the chassis 14. The base 21a of this reflection sheet 21 is placed such that it overlaps with the surface 18a of the front side of each LED board 18, namely mounting surface 18a mounting LEDs 17. The base 21a of the reflection sheet 21 has a lens insertion hole 21d opening in a place overlapping with each diffusing lens 19 (each LED 17) on the plan view, through which each defusing lens 19 is inserted (see FIGS. 3, 11 and 12).

As discussed above, a plurality of LED boards 18 is arranged parallel to each other in a matrix within the chassis 14, and now a detailed description will be made of the connection structure for electrically interconnecting three LED boards 18 of the plurality of LED boards 18 in the X-axis direction (the long side direction of the LED board 18) and for electrically connecting these three LED boards 18 to an external drive control circuit. As shown in FIG. 6, each of LED boards 18 (18A to 18C) constituting an LED board group 22 has a connecting portion 23 for electrically connecting with the adjacent LED board 18. On the other hand, of the LED boards 18 constituting the LED board group 22, a pair of LED boards 18 (18A, 18C) placed on both ends in the X-axis direction (in the direction that the LED boards 18 constituting the LED board group 22 are aligned) has an external connecting portion 24 electrically connecting a connector 25, which is electrically connected to an external drive control circuit. In the following, of the LED boards 18 of the LED board group 22, as shown in FIGS. 3 to 6, the most left LED board is referred to as the first LED board with denotation A, the center one is referred to as the second LED board with denotation B, and the most right one is referred to as the third LED board with denotation C. When the LED boards 18 are generally referred to without distinguishing them from each other, no denotation is attached to them. The first LED board 18A and the third LED board 18C at the both ends are the six-LED mounting type while the second LED board 18B at the center is the five-LED mounting type.

Of periphery side surfaces adjacent to (continuous to) both mounting surface 18a mounting the LED 17 and the surface 18b opposite to the mounting surface 18a of the LED board 18, the connecting portion 23 is provided on a surface 18c of the LED board 18 facing the adjacent LED board 18 in the X-axis direction. The surface 18c of the LED boards 18 facing the adjacent LED board 18, which is a surface forming the connecting portion 23, is a short side surface in the Y axis direction, and provided at one end of the LED board 18 in the long side direction. This connecting portion 23 is located in a recessed position from the mounting surface 18a toward the back side in the LED board 18, which avoids the connecting portion 23 from forming a step protruding toward the front side from the mounting surface 18a. Therefore, it reliably avoids a situation that the connecting portion 23 interferes the reflection sheet 21 layered on the mounting surface 18a of the LED board 18, that is, a situation that the reflection sheet 21 rides on the connecting portion 23 and deforms. The connecting portion 23 is located in a recessed position from the surface 18b opposite to the mounting surface 18a of the LED board 18 toward the front side, which avoids the connecting portion 23 from forming a step protruding toward the back side from the surface 18b opposite to the mounting surface 18a. Since the surface 18b opposite to the mounting surface 18a of the LED board 18 is a part supported by the base plate 14a of the chassis 14 from the back side, the configuration of the connecting portion 23 that does not protrude from the above described surface 18b allows the LED board 18 to be stably supported by the base plate 14a.

There are two types of the connecting portions 23, one is a concave connecting portion 23A provided on the surface 18c of the LED board 18 facing the adjacent LED board 18, and the other is a convex connecting portion 23B. The concave connecting portion 23A of one LED board 18 fits to the convex connecting portion 23B provided on the adjacent LED board 18 in the X-axis direction. When the connecting portions 23 need to be distinguished from each other, the concave connecting portion is denoted with A and the convex connecting portion is denoted with B, and when they are generally referred to without distinguishing from each other, no denotation is made on them. The convex connecting portion 23B is configured such that it protrudes in the X-axis direction from the surface 18c of LED board 18 facing the adjacent LED board 18, namely protrudes in the alignment direction of the LED boards 18 of the LED board group 22. In contrast, the concave connecting portion 23A only opens in the X-axis direction in the surface 18c of the LED board 18 facing the adjacent LED board 18, and is configured to surround the entire periphery of the convex connecting portion 23B fitted to the periphery of the concave connecting portion 23A. This configuration restricts the relative displacement of interconnected LED boards 18 in the Y-axis direction perpendicular to the X-axis direction (short side direction of LED board 18 (width direction)), and also in the Z-axis direction (the thickness direction of the LED board 18, the direction toward the optical member 15 from the LED 17). Thus the space held between the optical member 15 and the LED 17 mounted on the LED board 18 in the Z-axis direction is kept constant.

Specifically, the surface 18c of the first LED board 18A opposite to the second LED board 18B is provided with the convex connecting portion 23B, whereas the surface 18c of the second LED board 18B opposite to the first LED board 18A is provided with the concave connecting portion 23A. Similarly, the surface 18c of the second LED board 18B adjacent to the third LED board 18C is provided with the convex connecting portion 23B, whereas the surface 18c of the third LED board 18C adjacent to the second LED board 18B is provided with the concave connecting portion 23A. When the LED boards 18A to 18C of the LED board group 22 are interconnected with each other, the convex connecting portion 23B of the first LED board 18A and the convex connecting portion 23B of the second LED board 18B are fitted to the concave connecting portion 23A of the second LED board 18B and the concave connecting portion 23A of the third LED board 18C, respectively, and thus their electrical interconnections are made. In this connection work/operation, the surfaces 18c of the adjacent LED boards 18 only are abutted against one another in the X-axis direction, which provides an excellent workability. The direction of fitting and releasing the LED boards 18 accords with the X-axis direction. The pair of opposed short side surfaces of the second LED board 18B faces the first LED board 18A and the second LED board 18C respectively, and one surface 18c is provided with the concave connecting portion 23A and the other surface 18c opposite to one surface 18c is provided with the convex connecting portion 23B.

Now, the external connecting portion 24 will be described. Of the LED boards 18A to 18C of the LED board group 22, the first LED board 18A and the third LED board 18C at both ends of the LED board group 22 in the X-axis direction (in the alignment direction of the LED boards 18 of the LED board group 22) have the external connecting portion 24. The external connecting portion 24 is provided in a surface 18d of one pair of short side surfaces of the first LED board 18A and the third LED board 18C. The surface 18d is opposite to the surface 18c (surface having the connecting portion 23) facing the adjacent second LED board 18B, namely is located in the outermost end in the alignment direction of the LED boards 18 of the LED board group 22. The external connecting portion 24 provided in the first LED board 18A and the third LED board 18C has a concave shape in surface 18d of the LED board 18, and opens only in the X-axis direction. This concave external connecting portion 24 fits to a convex external connector 25. Since a pair of external connectors 24 of LED board group 22 both has a convex shape, the external connectors 25 fit to them may be the same component having a convex shape, resulting in reducing the number of components with respect to the connector 25 and simultaneously reducing the manufacturing cost.

The external connecting portions 24 provided in the first LED board 18A and the third LED board 18C have the same shape, and have the same shape as the concave connecting portions 23A provided in the second LED board 18B and the third LED board 18C. Therefore, while each external connecting portion 24 may selectively fit to the external connector 25 or the convex connecting portion 23B, and each concave connecting portion 23A may selectively fit to the external connector 25 or the convex connecting portion 23B. Thus, the external connecting portion 24 may be used as the concave connecting portion 23A, or adversely, the convex connecting portion 23A may be used as the external connecting portion 24. That is, the first LED board 18A and the second LED board 18B have the same connection structure except for the number of the LEDs 17 to be mounted, and thus the alignment order of the first LED board 18A and the second LED board 18B within the LED board group 22 may be inversed. Moreover, if, for example, the first LED board 18A and the second LED board 18B are formed to have the same long side dimension and have the same number of the LEDs 17 to be mounted, the first LED board 18A and the second LED board 18B may be formed in the same configuration, resulting in reducing the number of components with respect to the LED board 18 and simultaneously reducing the manufacturing cost.

As discussed above, in the LED boards 18A to 18C of the LED board group 22, the connecting portions 23 are connected with each other, and the external connector 25 is connected to the external connecting portion 24, and thus all the mounted LEDs 17 are connected in series to an external drive control circuit, which allows all the LEDs 17 included in the LED board group 22 to be collectively driven in series.

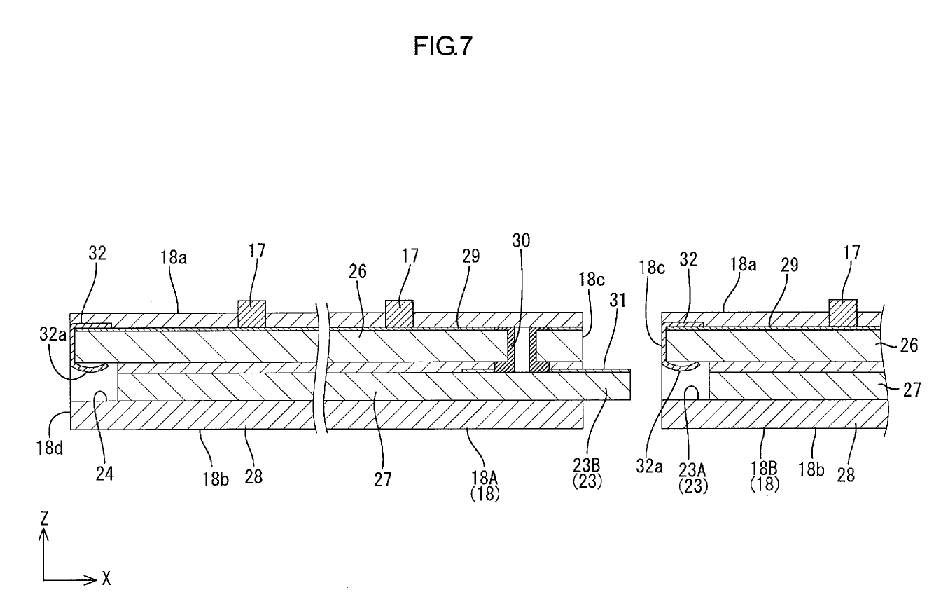

Now, the configurations of the first LED board 18A and the second LED board 18B of the LED boards 18 will be described in detail. As shown in FIG. 7, the first LED board 18A and the second LED board 18B have a configuration that the first board 26 where the LEDs 17 are mounted and the second board 27 having the convex connecting portion 23B are overlapped with each other, and that a molded portion 28 made of synthetic resin is molded. The first board 26 has: the LEDs 17 mounted on the front side surface of the first board 26; and a wiring pattern 29, which connects the LEDs 17 and is arranged throughout the length in the X-axis direction. A pair of the wiring patterns 29 is arranged so as to sandwich the LEDs 17 in the Y-axis direction and to be parallel to each other in the X-axis direction (FIG. 8). At the end of the convex connecting portion 23B of the first board 26, a hole penetrating in the thickness direction is formed and a through hole 30 plated with metallic material is formed at the edge of the hole. The second board 27 has substantially the same length as the first board 26 in the X-axis direction, and one end of the second board 27 is protruded from the first board 26, and this protruded portion forms the convex connecting portion 23B. A pair of wiring portions 31 is provided on the front-side surface of the second board 27 from the distal end of the convex connecting portion 23B to the place where the second board 27 overlaps with the through hole 30 of the first board 26 on the plan view. This wiring portion 31 is electrically connected to the wiring pattern 29 through the through hole 30 of the first board 26. The other end of the second board 27 opposite to the convex connecting portion 23B is recessed from the first board 26, and thus forms the concave connecting portion 23A or the concave external connecting portion 24. At one end of the first board 26 opposite to the convex connecting portion 23B, a pair of connecting terminals 32 connected to the wiring pattern 29 is provided. The connecting terminals 32 are bended toward the concave connecting portion 23A or the concave external connecting portion 24, and a part of connecting terminals 32 placed in the concave connecting portion 23A or the concave external connecting portion 24 is formed as the elastic contact part 32a having a high spring characteristic. The elastic contact part 32a may elastically contact to the wiring portion 31 of the convex connecting portion 23B or the terminal of the external connector 25 fitted to the concave connecting portion 23A or the concave external connecting portion 24. The molded portion 28 buries a space between the first board 26 and the second board 27, and covers the wiring pattern 29 and the connecting terminal 32 on the first board 26 from the front side and covers the second board 27 from the back side, and the end of the molded portion 28 is placed so as to face the elastic contact part 32a.

As shown in FIG. 6, the third LED board 18C has the same configuration as the above first LED board 18A and the above second LED board 18B, except that it has the concave connecting portion 23A at one end in the long side direction and the concave external connecting portion 24 at the other end, and that it has the contacting terminal 32a at both ends in the long side direction respectively (it does not have the through hole 30 and the wiring portion 31). Therefore, overlapping descriptions will be omitted.

The configuration of this embodiment has been described above, and now the functions of this embodiment will be described. The liquid crystal display device 10 shown in FIGS. 4 and 5 is manufactured by first manufacturing the liquid crystal panel 11 and the backlight device 12 separately and then combining these components using the bezel 13 and the like. In this respect, the assembling operation during manufacturing the backlight unit 12 will be described in details.

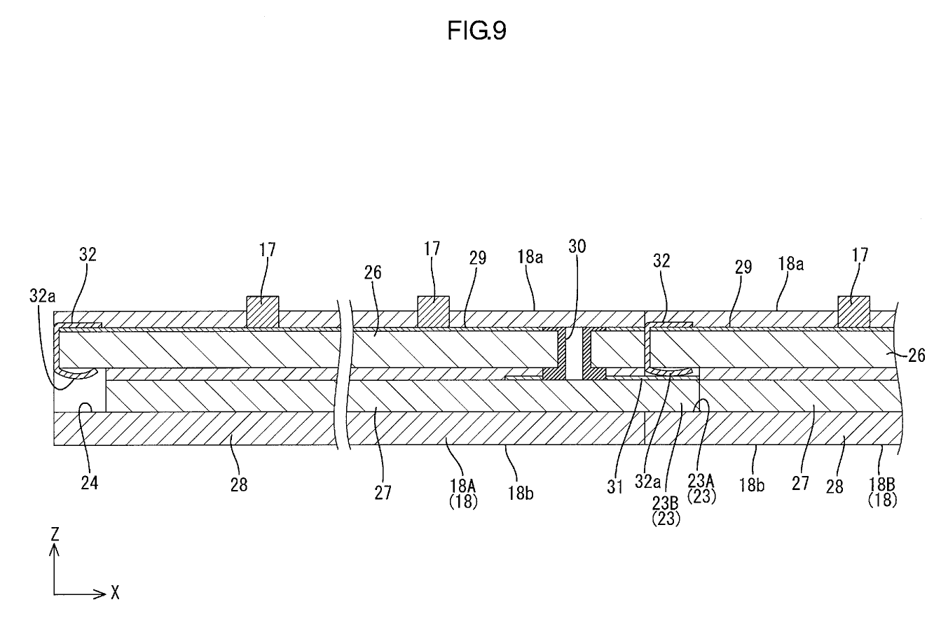

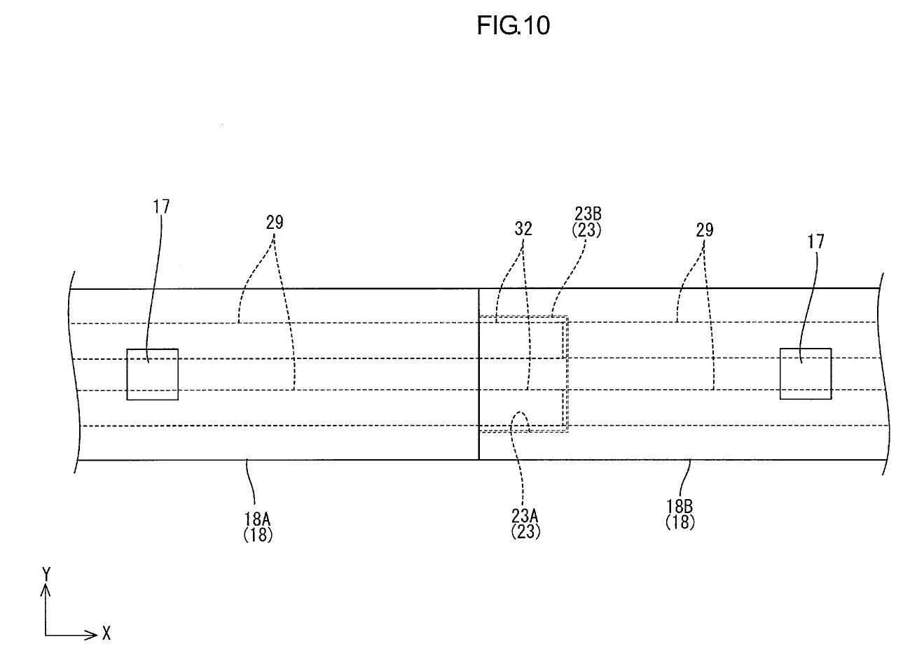

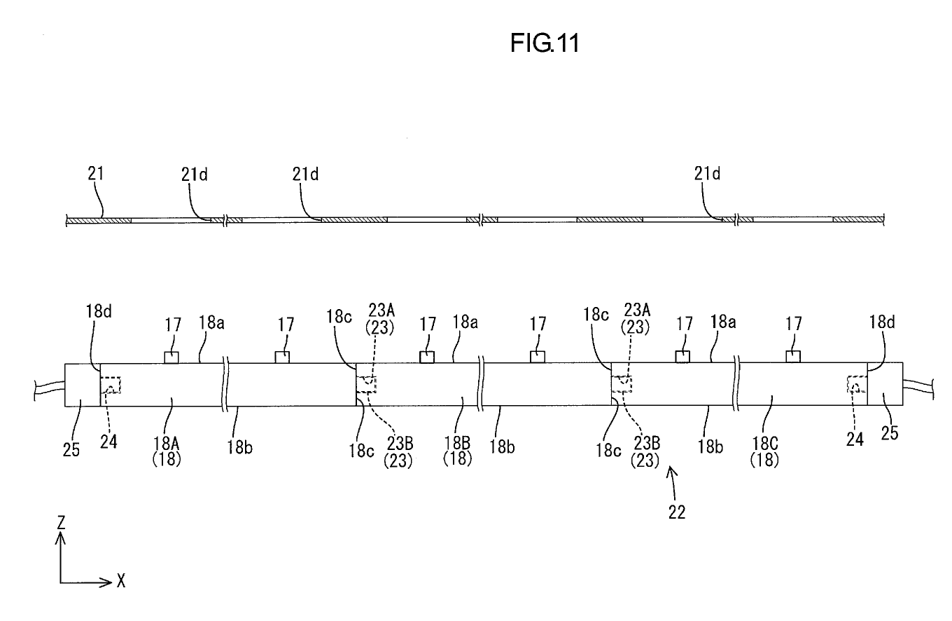

The LED boards 18 where the LEDs 17 and the diffusing lenses 19 have been mounted are connected to each other within the LED board group 22 (those aligned parallel to each other in the X-axis direction) before it is housed in the chassis 14. Specifically, the convex connecting portion 23B of the first LED board 18A and the convex connecting portion 23B of the second LED board 18B are fitted to the concave connecting portion 23A of the second board 18B and the concave connecting portion 23A of the third LED board 18C respectively in the X-axis direction. Then, as shown in FIGS. 9 and 10, the LEDs 17 on the LED boards 18A to 18C, which are adjacent to each other in the X-axis direction, are interconnected by elastically contacting the elastic contact part 32a of the connecting terminal 32 provided in each concave connecting portion 23A with the wiring portion 31 of the corresponding convex connecting portion 23B. This fitting operation is excellent in workability as the short side surfaces of the LED boards 18 may be simply abutted against each other. Since this connecting portion 23 is provided to the surface 18c facing the adjacent LED boards 18, which is a surface of the LED board 18 adjacent to the mounting surface 18a and a surface opposite to the mounting surface 18a, an operator may do this fitting operation as seeing this operation, and resulting in achieving a more excellent workability. Then, the LED board group 22 including three LED boards 18A to 18C is housed in the chassis 14. Subsequently, the connector 25 connected to an external drive control circuit is connected to each external connecting portion 24 of the LED board group 22 housed in the chassis 14. If the convex connector 25 is fitted to the concave external connecting portion 24, the elastic contact part 32a of the connecting terminal 32 is elastically contacted with the terminal of the connector 25 (see FIG. 9). In this manner, as shown in FIG. 11, all the mounted LEDs 17 included in the LED board group 22 are connected in series to the external drive control circuit, which allows all the LEDs 17 to be collectively driven in series.

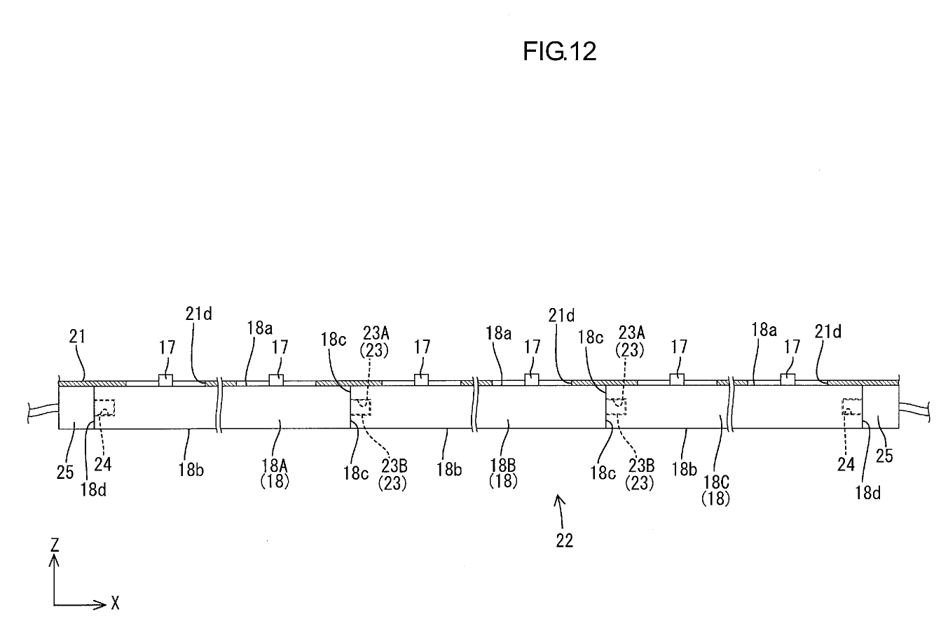

The connecting operation of the connector 25 is done in the above manner, and on the other hand, the placing operation of the reflection sheet 21 in the chassis 14 is done. When the reflection sheet 21 is accommodated in the chassis 14, the reflection sheet 21 is placed so as to overlap with the front side surface of the LED board 18, namely the mounting surface 18a mounting the LEDs 17 as shown in FIG. 12. The connecting portion 23 and the external connecting portion 24 provided to the LED boards 18 are provided to the surfaces 18c and 18d adjacent to both the mounting surface 18a and the surface opposite to the mounting surface 18a, and are thus prevented from protruding from the mounting surface 18a toward the front side. That is, since the connecting portion 23 and the external connecting portion 24 are prevented from making a step on the mounting surface of the LED board 18, the connecting portion 23 or the external connecting portion 24 does not interfere with the reflection sheet 21 when the reflection sheet 21 is placed along the mounting surface 18a. The reflection sheet 21 may be ensured to avoid deforming due to the connecting portion 23 and the external connecting portion 24. Moreover, since the mounting surfaces 18a of the adjacent LED boards 18 in the X-axis direction are flush with one another, there is not any steps between the mounting surfaces 18a of the LED boards 18, which avoids the deformation of the reflection sheet 21 layered on the mounting surfaces 18a. If the reflection sheet 21 does not deform, unevenness in light reflected by the reflection sheet 21 hardly occurs when the LEDs 17 are lighted, and thus emitted light in the backlight unit 12 and the liquid crystal display device 10 hardly causes uneven brightness, which allows a high uniformity ratio of the brightness of the emitted light. In this manner, a high quality of display in the liquid crystal display device 10 may be obtained.

After the reflection sheet 21 is placed in the chassis 14, each LED board 18 is held along with the reflection sheet 21 by attaching the hold member 20 to the chassis 14. Then, the optical member 15 is attached to the chassis 14 to cover the opening 14b. Regarding the attachment order of the optical member 15, the diffuser panel 15a is first attached, and then the optical sheet 15b is attached. As shown in FIGS. 4 and 5, the optical member 15 is received on the supporting plate 14d of the chassis 14 along the periphery thereof, and is supported by the support portion 20c of a certain hold member 20 at the center region thereof. When the frame 16 is attached to the chassis 14, the periphery of the optical member 15 is held between the frame 16 and the supporting plate 14d. In this manner, manufacturing of the backlight unit 12 is completed. When the manufactured backlight unit 12 and the liquid crystal panel 11 are assembled, the liquid crystal panel 11 is mounted on the frame 16, and the bezel 13 is attached on the front side of the liquid crystal panel 11 and screwed. In this manner, the liquid crystal panel 11 is held between the frame 16 and the bezel 13 and is integrated with the backlight unit 12, and then manufacturing of the liquid crystal display device 10 is completed.

As described above, the backlight unit 12 of this embodiment has: the LEDs 17, which are a plurality of light sources; at least two LED boards 18 mounting the LEDs 17; the connecting portion 23 electrically interconnecting the at least two LED boards 18; and the reflection sheet 21 reflecting light, which is placed on the mounting surface 18a of the LED boards 18 mounting the LEDs 17. The connecting portion 23 is provided on the surface 18c adjacent to both the mounting surface 18a of the LED board 18 and the surface 18b opposite to the mounting surface 18a.

In this manner, at least two LED boards 18 are electrically interconnected by the connecting portion 23, and light from the LEDs 17 is reflected by the reflection sheet 21 placed on the mounting surface 18a of the LED boards 18, resulting in that the light is efficiently emitted. According to this embodiment, as the connecting portion 23 is provided on the surface 18c of the LED board 18 adjacent to both the mounting surface 18a mounting the LEDs 17 and the surface 18b opposite to the mounding face 18a, a step is less likely to be formed on the mounting surface 18a mounting the LEDs 17, on which the reflection sheet 21 is placed, as compared with a case that a connecting portion is provided on the mounting surface 18a of the LED board 18 mounting the LED 17. Thus deformation is less likely to be formed in the reflection sheet 21 provided on the mounting surface 18a mounting the LEDs 17, resulting in that unevenness of light reflected by the reflection sheet 21 is less likely to occur.

In a case that a connecting portion is provided to the mounting surface 18a of the LED board 18 mounting the LEDs 17, in order to avoid the deformation of the reflection sheet 21, a technique of forming a hole in the reflection sheet 21 to pass the connecting portion through the hole may be used, but such a technique causes the connecting portion to be exposed through the hole, resulting in that the uniformity of optical reflectance may be harmed. However, since this embodiment does not form any holes in the reflection sheet 21 and thus avoids deformation of the reflectance sheet 21, the uniformity of the optical reflectance is maintained, and unevenness in emitted light is less likely to occur.

If a connecting portion is provided to the surface 18b of the LED board 18 opposite to the mounting surface 18a, the connecting portion may be hardly seen from the side of the mounting surface 18a when, for example, connecting the LED boars 18 to each other, which may worsen the workability, and may inhibit slimming down of the backlight unit 12. To the contrary, in this embodiment of the present invention, there are advantages that the connecting portion 23 may be easily seen from the side of the mounting surface 18a when connecting the LED boards 18 to each other, and is excellent in the workability of connection, and may slim down the backlight device 12.

In this embodiment, since at least two LED boards 18 are electrically interconnected by the connecting portion 23, when several types of the backlight unit 12 having different sizes are manufactured, this may be dealt with by changing the number of the LED boards 18 interconnected by the connecting portion 23. As compared with a case that the LED board 18 having a specific size is prepared for each type of the backlight unit 12, the number of the types of the LED boards 18 may be reduced, resulting in the reduction of manufacturing cost may be achieved.

The at least two LED boards 18 have an elongated shape. In this configuration, the elongated LED boards 18 are electrically interconnected by the connecting portion 23.

The at least two LED boards 18 are aligned in the long side direction thereof. In this configuration, since the at least two LED boards 18 interconnected by the connecting portion 23 are aligned in the long side direction thereof, it becomes suitable for upsizing the backlight unit 12. As the backlight unit 12 is upsized, the reflection sheet 21 is also upsized and the occurrence of deformation is concerned, but the deformation of the reflection sheet 21 is effectively prevented by this embodiment.

The connecting portion 23 is provided at an end of the LED board 18 in the long side direction. In this configuration, the connecting portion 23 interconnecting the at least two LED boards 18 aligned in the long side direction may be formed in a small size.

The connecting portion 23 is provided to the short side surface 18c of the LED board 18. In this configuration, when the at least two LED boards 18 are aligned in the long side direction thereof, their short side surfaces 18c face each other. Providing the connecting portion 23 to the short side surfaces 18c of the LED boards 18 provides the excellent workability of connecting operation.

The at least two LED boards 18 include those having different lengths in the long side direction. In this configuration, as the at least two LED boards 18 aligned in the long side direction, those having different lengths in the long side direction may be used in combination. Thus, when the backlight units 12 of different sizes are manufactured, this configuration may appropriately deal with the backlight units 12 of various sizes.

The at least two LED boards 18 interconnected by the connecting portion 23 constitute one LED board group 22, and a plurality of LED board groups 22 is intermittently arranged parallel to each other in the short side direction of the LED boards 18. This configuration is suitable for further upsizing the backlight unit 12.

The plurality of LEDs 17 is aligned on the LED board 18 parallel to each other in the long side direction thereof. In this configuration, the plurality of LEDs 17 is efficiently provided on the LED board 18, which is suitable for achieving higher brightness and the like.

The at least two LED boards 18 are aligned in one direction along the mounting surface 18a, and the connecting portion 23 is provided to the surface 18c facing the adjacent LED board 18 of the LED boards 18. One LED board 18 of the at least two LED boards 18 is provided with the concave connecting portion 23A as the connecting portion 23, while another LED board 18 adjacent to the LED board 18 having the concave connecting portion 23A is provided with the convex connecting portion 23B fitted to the concave connecting portion 23A as the connecting portion 23. In this configuration, the LED boards 18 are connected with each other by abutting surfaces 18c of the adjacent LED boards 18 and fitting the convex connecting portion 23B to the concave connecting portion 23A, which achieves the excellent workability of connecting operation.

In the LED board 18 having the concave connecting portion 23A, the surface 18c (18d) opposite to the surface 18c provided with the concave connecting portion 23A is provided with the convex connecting portion 23B, while in another LED board 18 having the convex connecting portion 23B, the surface 18c (18d) opposite to the surface 18c provided with the convex connecting portion 23B is provided with the concave connecting portion 23A. In this configuration, the adjacent LED boards 18 are formed to have the same structure, which achieves the reduction of manufacturing cost.

The convex connecting portion 23B and the periphery of the concave connecting portion 23A are placed so as to overlap with each other in the thickness direction of the LED boards 18. In this configuration, the adjacent LED boards 18 are positioned with respect to the thickness direction of the LED boards 18. In this manner, each LED 17 mounted on the adjacent LED boards 18 is prevented from being displaced in the thickness direction of the LED boards 18.

The optical member 15 is provided so as to face the LEDs 17 arranged with a space at the light emitting side, and the convex connecting portion 23B and the periphery of the concave connecting portion 23A are placed so as to overlap with each other in the direction toward the optical member 15 from the LEDs 17. In this configuration, the adjacent LED boards 18 are positioned with respect to the direction toward the optical member 15 from the LEDs 17. In this manner, the space between the LEDs 17 and the optical member 15 is held constant, and thus unevenness in emitted light is even less likely to occur.

Of a pair of the LED boards 18A and 18C located at both ends of the at least two LED boards 18 in the alignment direction, the surface 18d opposite to the surface 18c provided with the connecting portion 23 is provided with the external connecting portion 24, which is electrically connected to the external connector 25. In this configuration, of the pair of the LED boards 18A and 18C located at both ends of the at least two LED boards 18 in the alignment direction, the LED board 18A and the LED board 18C are each electrically connected to the external connector 25 through the external connecting portion 24 provided on the surface 18d opposite to the surface 18c provided with the connecting portion 23, which interconnects the adjacent LED boards 18. Since the external connecting portion 24 is provided in the surface 18d opposite to the surface 18c provided with the connecting portion 23, the external connecting portion 24 is less likely to cause a step on the mounting surface 18a mounting the LEDs 17 where the reflection sheet 21 is placed. In this manner, deformation is less likely to be formed in the reflection sheet 21 provided on the mounting surface 18a mounting the LEDs 17, resulting in that unevenness of light reflected by the reflection sheet 21 is less likely to occur.

The external connecting portion 24 provided in the pair of LED boards 18A and 18C has a concave shape to be fitted to the convex connector 25. In this configuration, since a pair of external connecting portions 24 provided on the pair of LED boards 18A and 18C both have a convex shape, a pair of external connectors 25 may be formed as the same component having a convex shape. In this manner, the manufacturing cost of the external connectors 25 may be reduced.

The convex connecting portion 23B is configured such that it protrudes in the alignment direction of the at least two LED boards 18, while the concave connecting portion 23A opens in the alignment direction of the at least two LED boards 18 and surrounds the convex connecting portion 23B with the periphery thereof. In this configuration, since the convex connecting portion 23B is surrounded by the periphery of the concave connecting portion 23A if the convex connecting portion 23B is fitted to the concave connecting portion 23A, they are positioned with respect to the alignment direction of the at least two LED boards 18 (which is the mating direction) and also to the direction perpendicular to the alignment direction.

The connecting portion 23 is located in a recessed position from the mounting surface 18a of the LED board 18 toward the surface 18b of the back side thereof. Such a configuration avoids forming a step protruding from the mounting surface 18a of the LED board 18. Therefore, it securely avoids a situation that the reflection sheet 21 provided on the mounting surface 18a of the LED board 18 rides on the connecting portion 23 and deforms.

The connecting portion 23 is located in a recessed position from the surface 18b opposite to the mounting surface 18a of the LED board 18 toward the mounting surface 18a. Such a configuration avoids forming a step protruding from the surface 18b of the LED board 18 opposite to the mounting surface 18a. This configuration is suitable for installing the LED board 18 in the backlight unit 12.

The connecting portion 23 is formed integrally with the LED board 18. In this configuration, the manufacturing cost for the LED boards 18 may be reduced.

The light source is the LED 17. In this configuration, higher brightness and lower power consumption are achieved.

The light emitting side of the LED 17 has the diffusing lens 19 diffusing light from the LED 17. In this configuration, this diffusing lens 19 may emit and diffuse light emitted from the LED 17. In this manner, it is less likely to cause unevenness in emitted light, and thus the number of the LEDs 17 to be mounted may be reduced, which allows reducing the cost.

### Second Embodiment

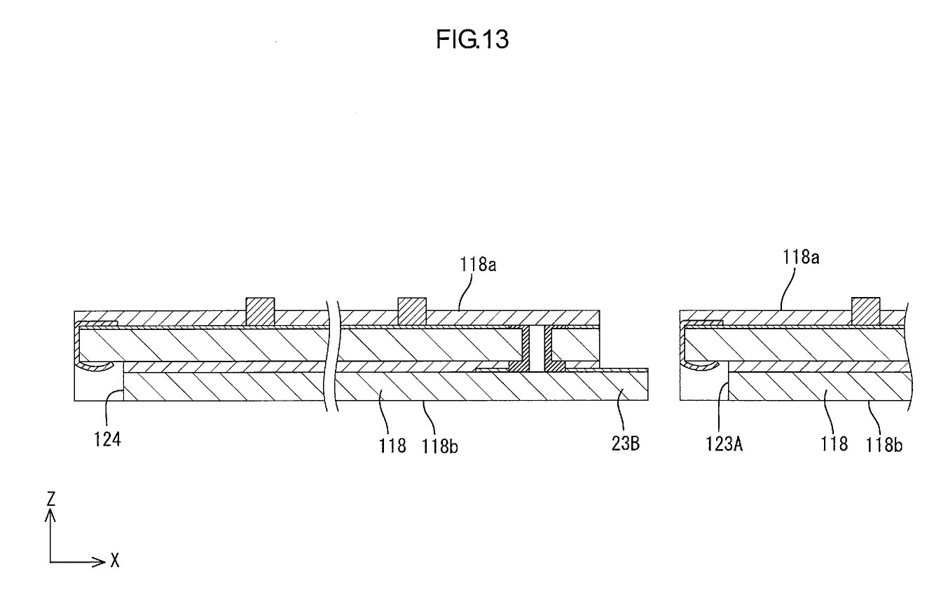

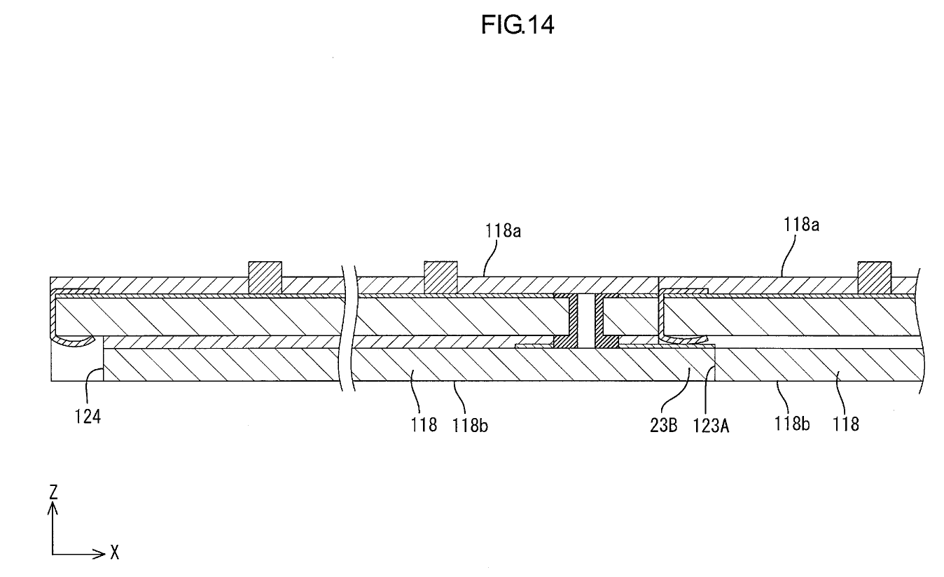

A second embodiment of the present invention will be described with reference to FIG. 13 or 14. In the second embodiment, the shapes of a concave connecting portion 123A and an external connecting portion 124 are changed. Overlapping descriptions on the same structures, operations, and advantages as those of the above first embodiment will be omitted.

As shown in FIGS. 13 and 14, the concave connecting portion 123A and the external connecting portion 124 open in the X-axis direction, which is the alignment direction of an LED boards 118 (the long side direction of the LED board 118, the alignment direction of the LED boards 118), and also open in the Z-axis direction perpendicular to the X-axis direction (the thickness direction of the LED board 118, the direction of inserting/removing the LED board 118 into/from the chassis 14). Since the concave connecting portion 123A and the external connecting portion 124 open in the Z-axis direction toward the back side, the concave connecting portion 123A and the external connecting portion 124 may be fitted to the convex connecting portion 23B or the external connector 25 (not shown), respectively, by assembling the LED boards 118 having the concave connecting portion 123A or the external connecting portion 124 onto the convex connecting portion 23B or the external connector 25 in the Z-axis direction from the front side. That is, in this embodiment, to connect the LED boards 118 adjacent to each other in the X-axis direction or connect the connector 25 to the LED board 118, one of the two methods may be selected. The two methods include one in which the connection structure is fitted to along the X-axis direction and another one in which the connection structure is fitted to along the Z-axis direction. In this configuration, one may select an appropriate assembling method depending on the design of other components such as the chassis 14, resulting in increasing the degree of flexibility in work/operation and improving the workability. In this embodiment, the convex connecting portion 23B is flush with the surface 118b of the LED board 118 opposite to the mounting surface 118a.

As described above, according to this embodiment, the convex connecting portion 23B protrudes from the LED board 118 in the alignment direction of at least two LED boards 118, while the concave connecting portion 123A of the LED board 118 opens in the alignment direction of the at least two LED boards 118 and also in the direction perpendicular to the alignment direction. In this configuration, to fit the convex connecting portion 23B to the concave connecting portion 123A, one may select either of the fitting method of fitting along the alignment direction of the at least two LED boards 118, or the fitting method of fitting along the direction perpendicular to the alignment direction. In this manner, the workability with respect to connection may be improved.

### Third Embodiment

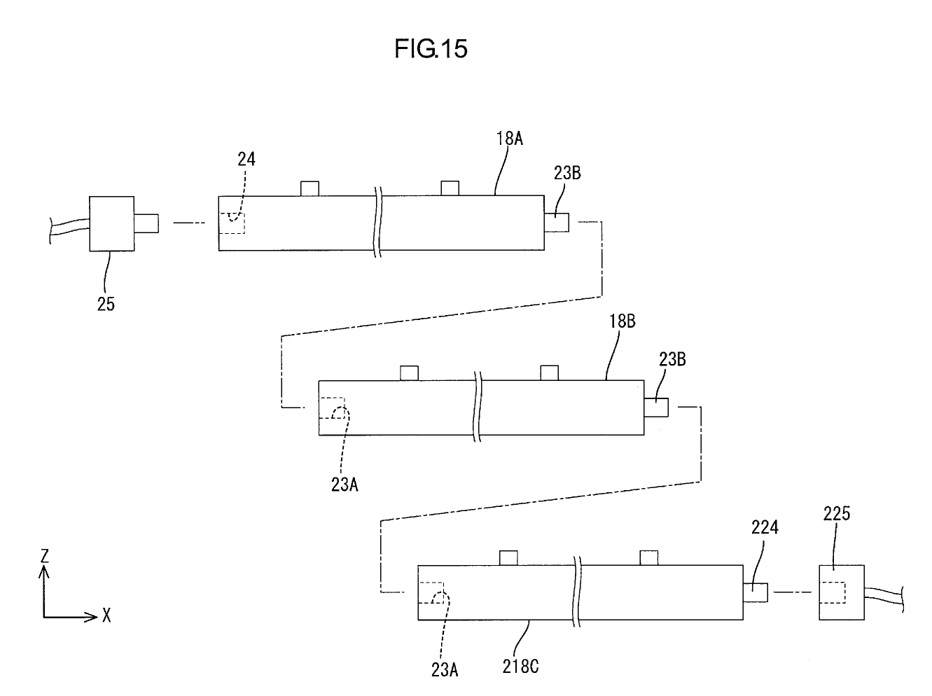

A third embodiment of the present invention will be described with reference to FIG. 15. In this embodiment, the shapes of a third LED board 218C and a connector 225 connected to the third LED board 218C are changed. Overlapping descriptions on the same structures, operations, and advantages as those of the above first embodiment will be omitted.

An external connecting portion 224 of the third LED board 218C is the convex external connecting portion 224 having a convex shape. Since the convex external connecting portion 224 has the same shape as the convex connecting portion 23B of other LED boards 18A and 18B, it may fit to the concave connecting portion 23A of the LED boards 18A, 18B and 218C. That is, the convex external connecting portion 224 may be used as the convex connecting portion 23B, and the convex connecting portion 23B may be used as a convex external connecting portion 124. On the other hand, the connector 25 connected to the first LED board 18A has a convex shape, while the connector 225 connected to the third LED board 218C has a concave shape so as to fit to the above convex external connecting portion 224. Since this connector 225 has the same shape as the concave connecting portion 23A of the LED boards 18A, 18B and 218C, it may fit to the convex connecting portion 23B of the LED boards 18A and 18B. Accordingly, the first LED board 18A and the third LED board 218C have the same configuration including the long side length and the number of the LEDs 17 to be mounted, which allows reducing manufacturing cost of both the LED boards 18A and 218C. Moreover, the LED boards 18A, 18B and 218C have the same connection structure except for the number of the LEDs 17 to be mounted, and thus the alignment order of the LED board group 22 may be changed. Furthermore, it is possible to make all the LED boards 18, 18B and 218C to be the same structure by making them to have the same long side length and the same number of the LEDs 17 to be mounted, which allows further reducing the manufacturing cost of the LED boards 18, 18B and 218C.

As described above, according to this embodiment, the LED boards 18A of either LED board 18A or 218C has: the convex connecting portion 23B; and the concave external connecting portion 24, which is configured to fit to the convex connector 25 (as external connecting portion 24) and has the same shape as the concave connecting portion 23A. The other LED board 218C has: the concave connecting portion 23A; and the convex external connecting portion 224 (as external connecting portion 24), which is configured to fit to a concave connector 225 and has the same shape as the convex connecting portion 23B. In this configuration, since the concave external connecting portion 24 has the same shape as the concave connecting portion 23A, and the convex external connecting portion 224 has the same shape as the convex connecting portion 23B, the LED boards 18A, 18B and 218C may be formed as the same component. In this manner, the manufacturing cost of the LED boards 18, 18B and 218C may be reduced.

### Other Embodiment

The present invention is not limited to the above embodiments explained in the above description. The following embodiments may be included in the technical scope of the present invention, for example.

(1) Besides the above-described embodiments, the present invention also includes an embodiment that a first LED board is provided with a concave connecting portion, a third LED board is provided with a convex connecting portion, and a second LED board is provided with a convex connecting portion on the surface facing the first LED board and provided with a concave connecting portion on the surface facing the third LED board.

(2) Besides the above described embodiment in (1), the present invention also includes an embodiment that a second LED board is provided with convex connecting portions, one on the surface facing the first LED board and the other on the surface facing the third LED board, and the first LED board and the third LED board are each provided with a concave connecting portion. On the contrary, the second LED board is provided with concave connecting portions, one on the surface facing the first LED board and the other on the surface facing the third LED board, and the first LED board and the third LED board are each provided with a convex connecting portion.

(3) Besides the above described embodiments, the present invention also includes an embodiment that a first LED board is provided with a convex external connecting portion, a connector connected to the concave external connecting portion has a concave shape, the third LED board is provided with a concave external connecting portion, and a connector connected to the concave external connecting portion has a convex shape. The present invention also includes an embodiment that the first LED board and the third LED board are each provided with a convex external connecting portion, and each connector connected to them has a concave shape.

(4) Although in the above embodiments, the number of the LED boards arranged parallel to each other in the X-axis direction (the number of the LED boards constituting an LED board group) is three, the number of the LED boards arranged parallel to each other in the X-axis direction may be, of course, two or four or more.

(5) Although in the above embodiment, it has been described that the LED boards of five-LED mounting type, six-LED mounting type and eight-LED mounting type are suitably combined and used, the present invention also includes those using an LED board mounting a number of LEDs other than five, six and eight (four or less, or seven, or nine or more). In this case, the long side dimension of the LED board may be suitably changed depending on the number of LEDs to be mounted.

(6) Although in the above embodiment, those, in which the plurality of types of LED boards having different long side dimensions and different numbers of LEDs to be mounted is used in combination, are mainly shown, it is, of course, possible to use only LED boards having the same long side dimension and the same number of LEDs to be mounted. In this case, only one type of LED boards having the same structure including the structure of a connecting portion and an external connecting portion may be used by adopting the technique described in the third embodiment, resulting in further reducing the cost with respect to the LED boards.

(7) Although in the above second embodiment, the concave connecting portion and the concave external connecting portion open in the X-axis direction and also open in the Z-axis direction toward the back side, the concave connecting portion and the concave external connecting portion may open in the X-axis direction and also open in the Z-axis direction toward the front side, for example. Furthermore, the concave connecting portion and the concave external connecting portion may open in the X-axis direction and also open in the Z-axis direction toward both the front side and the back side. Besides, the concave connecting portion and the concave external connecting portion may open in the X-axis direction and also open in the Y-axis direction into one side or both sides.

(8) Although in the above second embodiment, the convex connecting portion is flush with the surface of the LED board opposite to the mounting surface, the present invention also includes an embodiment that the convex connecting portion is flush with the mounting surface of the LED board. The present invention also includes an embodiment that the convex connecting portion protrudes a little from the mounting surface or the surface opposite to the mounting surface of the LED board.

(9) Although in the above embodiments, the LED boards aligned along the long side direction thereof are interconnected by the connecting portion, the present invention may apply to an embodiment that the LED boards aligned along the short side direction are interconnected by the connecting portion. In this case, the connecting portion may be provided on a long side surface of each LED board.

(10) Although in the above embodiments, the external connecting portion is provided on a short side surface of the LED board, the present invention may apply to an embodiment that the external connecting portion is provided on a long side face of the LED board.

(11) Although in the above embodiments, the convex or concave external connecting portion is formed in the same shape as the convex or concave connecting portion in order to provide commonality between them, the present invention may also include an embodiment that the convex or concave external connecting portion is formed in a shape different from the convex or concave connecting portion in order to inhibit commonality between them.

(12) Although in the above embodiments, connecting portions includes a concave connecting portion and a convex connecting portion fitted to each other, the present invention may also include an embodiment that a connecting portion interconnecting LED boards are made by welding or soldering.

(13) Although in the above embodiments, LED boards having an elongated shape are used, the present invention may also include an embodiment that an LED board having a square shape is used.

(14) Although in the above embodiments, a blue LED chip emitting a single color of blue is included, and a type of an LED emitting white light by a phosphor is used, the present invention may also include an embodiment that an LED chip emitting a single color of ultraviolet light (blue-purple light) is included, and a type of an LED emitting white light by a phosphor is used.

(15) Although in the above embodiments, a blue LED chip emitting a single color of blue is included, and a type of an LED emitting white light by a phosphor is used, the present invention may also include an embodiment that an LED including three types of LED chips emitting red color, green color and blue color respectively is used. Besides, the present invention also includes an embodiment that an LED includes three types of LED chips emitting C (cyan), M (magenta), Y (yellow) respectively.

(16) Although in the above embodiments, a connector is exemplified as a connection component connected to an external drive control circuit, it is possible to use a connection component such as a FPC other than a connector.

(17) Although in the above embodiments, the surface of the LED board opposite to the mounting surface is directly supported by the base plate of the chassis, the present invention may also include an embodiment that a heat-dissipating member is provided between the base plate of the chassis and the LED board, and thus the surface of the LED board opposite to the mounting surface is supported by the heat-dissipating member, for example.

(18) Although in the above embodiments, the liquid crystal panel and the chassis are vertically placed with the short side direction coinciding with the vertical direction, the present invention may also include an embodiment that the liquid crystal panel and the chassis are vertically placed with the long side direction coinciding with the vertical direction.

(19) Although in the above embodiments, a TFT is used as the switching element of the liquid crystal display device, the present invention may apply to a liquid crystal display device using a switching element other than TFT (for example, thin-film diode (TFD)), and apply to a liquid crystal display device of monochrome display, other than a liquid crystal display device of color display).

(20) Although in the above embodiments, a liquid crystal display device using a liquid crystal panel as a display panel is exemplified, the present invention may apply to display devices using other types of display panels.

(21) Although in the above embodiments, a television receiver having a tuner is exemplified, the present invention may apply to display devices without any tuner.

(22) Besides the above embodiments, the specific structure of an LED board (for example, the specific shape of each connecting portion (external connecting portion), the connection structure for connection between a wiring pattern interconnecting LEDs and a wiring portion or connection terminal of a connecting portion (external connecting portion), and the like) may be suitably changed. The configuration position of the LED boards (such as each base member, a through hole, a connection terminal, a wiring portion, or a molded portion) may be suitably changed or omitted.

### EXPLANATION OF SYMBOLS

10: Liquid crystal display device (Display device)
11: Liquid crystal panel (Display panel)
12: Backlight unit (Lighting device)
15: Optical member
17: LED (light source)
18, 18A, 18B, 18C, 118, 218C: LED board (light-source board)
18a, 118a: Mounting surface
18b, 118b: Surface opposite to a mounting surface
18c: Facing surface (surface adjacent to both mounting surface and surface opposite to the mounting surface, short side surface)
18d: Surface opposite to a surface having a connecting portion
19: Diffusing lens
21: Reflection sheet (reflection member)
22: LED board group (light-source board group)
23: connecting portion
23A, 123A: Concave connecting portion
23B: Convex connecting portion
24, 124: External connecting portion (concave external connecting portion)
224: Convex external connecting portion
25, 225: Connector (Connecting component)
TV: Television receiver

1. A lighting device comprising:
a plurality of light sources;
at least two light-source boards each having a mounting surface on which the plurality of light sources are mounted, an opposite surface that is a surface opposite to the mounting surface, and a side surface that is adjacent to both of the mounting surface and the opposite surface;
a connecting portion provided on the side surface of each light source board and configured to electrically connect the at least two light-source boards; and
a reflection member provided on the mounting surface of each light-source board and configured to reflect light.

2. The lighting device according to claim 1, wherein each of the at least two light-source boards has an elongated shape.

3. The lighting device according to claim 2, wherein the at least two light-source boards are aligned along a long-side direction of the light-source boards.

4. The lighting device according to claim 3, wherein the connecting portion is provided at an end of each light-source board in the long-side direction of the light-source board.

5. The lighting device according to claim 4, wherein the connecting portion is provided on a short side surface of each light-source board.

6. The lighting device according to claim 3, wherein the at least two light-source boards include a plurality of light-source boards having different lengths in the long-side direction.

7. The lighting device according to claim 3, wherein:
the at least two light-source boards connected by the connecting portion configure a light-source board group; and
a plurality of light-source board groups is intermittently arranged parallel to each other in a short-side direction of the light-source boards.

8. The lighting device according to claim 2, wherein the plurality of light sources is arranged along the long-side direction of the light-source boards.

9. The lighting device according to claim 1, wherein:
the at least two light-source boards are aligned in one direction along the mounting surface and each of the at least two light-source boards has a facing surface that faces each other;
the connecting portion is provided on the facing surface of each light-source board; and
the connecting portion includes a concave connecting portion and a convex connecting portion that are configured to be fitted to each other, the concave connecting portion is provided on one of the at least two light-source boards, and the convex connecting portion is provided on another one of the at least two light-source boards.

10. The lighting device according to claim 9, wherein each of the light-source boards has two side surfaces that are provided on opposite sides, and the convex connecting portion is provided on one of the two side surfaces and the concave connecting portion is provided on another one of the two side surfaces.

11. The lighting device according to claim 9, wherein the convex connecting portion and a periphery of the concave connecting portion are provided to overlap each other in a thickness direction of the light-source board.

12. The lighting device according to claim 11, further comprising an optical member provided on a light exit side to face the light sources with a gap therebetween, wherein the convex connecting portion and the periphery of the concave connecting portion are provided to overlap with each other in a direction from the light sources toward the optical member.

13. The lighting device according to claim 9, wherein a pair of the light-source boards of the at least two light-source boards that are located at both ends in an alignment direction in which the at least two light-source boards are aligned includes an external connecting portion provided on a surface of each of the pair of the light-source boards that is opposite to the side surface having the connecting portion thereon, and the external connecting portion is electrically connected to an external connection component.

14. The lighting device according to claim 13, wherein the external connecting portion provided on each of the pair of light-source boards has a concave shape to which the external connection component having a convex shape is fitted.

15. The lighting device according to claim 13, wherein:
one of the pair of light-source boards includes the convex connecting portion, and the external connecting portion having a concave shape same as the concave connecting portion configured to fit to the connection component having a convex shape; and
the other one of the pair of light-source boards includes the concave connecting portion, and the external connecting portion having a convex shape same as the convex connecting portion configured to fit to the connection component having a concave shape.

16. The lighting device according to claim 9, wherein:
the convex connecting portion is protruded from the light-source board in the alignment direction of the at least two light-source boards; and
the concave connecting portion is open in the alignment direction of the at least two light-source boards and has a periphery that surrounds the convex connecting portion.

17. The lighting device according to claim 9, wherein:
the convex connecting portion is protruded from the light-source board in the alignment direction of the at least two light-source boards; and
the concave connecting portion is open in the alignment direction of the at least two light-source boards and also open in a direction perpendicular to the alignment direction.

18. The lighting device according to claim 1, wherein the connecting portion is provided to be flush with the mounting surface of the light-source board, or is provided to be recessed from the mounting surface toward the opposite surface.

19. The lighting device according to claim 1, wherein the connecting portion is provided to be flush with the opposite surface of the light-source board, or is provided to be recessed from the opposite surface toward the mounting surface.

20. The lighting device according to claim 1, wherein the connecting portion is formed integrally with the light-source board.

21. The lighting device according to claim 1, wherein the light source is an LED.

22. The lighting device according to claim 1, further comprising a diffusing lens provided on a light exit side of the light source and configured to diffuse light from the light source.

23. A display device comprising:
the lighting device according to claim 1; and
a display panel displaying using light from the lighting device.

24. The display device according to claim 23, wherein the display panel is a liquid crystal panel having liquid crystal sealed between a pair of substrates.

25. A television receiver, comprising the display device according to claim 23.
